(19) United States
(12) Patent Application Publication
(10) Pub. No.: US 2002/0040479 A1
(43) Pub. Date: Apr. 4, 2002

(54) Method and apparatus for streaming content via a network

(76) Inventors: Eric Ehrman, Beit Shemesh (IL); David Elliot Goldfarb, Beit Shemesh (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/961,266

(22) Filed: Sep. 25, 2001

Related U.S. Application Data
(60) Provisional application No. 60/237,365, filed on Oct. 4, 2000.

(51) Int. Cl. H04N 7/173

(52) U.S. Cl. 725/95; 725/86

(57) ABSTRACT

A method for streaming content via a network to a receiver includes the steps of providing a plurality of streams to a plurality of different suppliers and receiving multiple streams from the different suppliers. The multiple streams together from the content.

### FIELD OF THE INVENTION

The present invention relates to methods and apparatus for streaming content via a network.

### BACKGROUND OF THE INVENTION

Transmitting broadband signals through the Internet is currently of interest. Some systems transmit such wide bandwidth signals with a client-server architecture in which a client requests, via the Internet a video or music file and a server sends the requested file. For music, where files are small, this may be acceptable. However, for video, it is impossible, as video files are large and they congest the network if too many are sent at once.

One solution, implemented by Akamai Technologies Inc.. is to use ‘edge servers’, in which multiple geographically-separated servers are spread throughout an area to be served (such as the United States). Unfortunately, as clients get connected to high bandwidth local lines, with DSL or cable modems, each client can receive large amounts of data at once, while server bandwidth is growing at a much slower rate. This means that the edge servers can each handle only a relatively small number of simultaneous clients.

Napster Inc. solves the problem differently, by having a central database listing where the music is stored and by having the users obtain the music from files stored on other users' machines. This is known as peer-to-peer (P2P) operation. P2P works well for music files, which are relatively small and can be downloaded quickly even across relatively low bandwidth connections. However, video across a network typically must be viewed as it is being downloaded (that is “Streamed”) and this requires a wide bandwidth download.

Streaming a video is considered a necessity since consumers do not want to wait many hours to see a movie and they do not necessarily, have space on their computers to store an entire movie. Moreover, streaming at real time affords more security to the vendors as otherwise it is easier for the consumer to save the downloaded complete file for future use or private redistribution.

The system of Napster Inc. does not work well for video files. This is because DSL and cable modems only have a narrow bandwidth for uploads. Thus, although the receiving computer (or peer) may have a wide bandwidth for download, the sending peer cannot send such a wide bandwidth stream of data to the receiving computer.

### BRIEF DESCRIPTION OF THE DRAWINGS

The present invention will be understood and appreciated more fully from the following detailed description taken in conjunction with the appended drawings in which:

FIG. 1 is a schematic illustration of a streaming, content system, constructive and operative in accordance with a preferred embodiment of the present invention;

FIG. 2A is a schematic illustration of a content dividers useful with the system of FIG. 1;

FIG. 2B is a schematic illustration of an exemplary division of a content stream, useful in understanding the operation of the content divider of FIG. 2A:

FIG. 3 is a schematic illustration of a supplier forming part of the system of FIG. 1;

FIG. 4 is a schematic illustration of a recombiner forming part of the system of FIG. 1; and

FIG. 5 is a schematic illustration of a streaming content manager forming part of the system of FIG. 1.

### DETAILED DESCRIPTION OF THE PRESENT INVENTION

Applicants have realized that the ‘backbone’ of a wide area network such as tie Internet is incapable of delivering high bandwidth datastreams to computers connected to the Internet via broadband edge connections such as DSL or cable. Even when the user's connection is capable of delivering high bandwidth datastreams, congestion further upstream typically renders such delivery impossible

However, Applicants have realized that such broadband user connections can fill their entire bandwidth capacity by receiving multiple datastreams simultaneously, especially when coming from multiple sources.

Thus, for a user to receive a wide bandwidth signal, he need only create multiple connections to the Internet or other network. For this to be useful, particularly for extremely large datastreams, such as video streams (e.g. movies) to be played on receipt, the data being sent must be divided into many pieces, herein called “streams”, each of which may be sent on a separate connection.

Applicants have also realized that each such stream will require a relatively low bandwidth connection and that the stream may be sent from a computer having a low bandwidth upload connection (i.e. from the computer to the Internet). Thus, such a distribution network may be implemented as a peer-to-peer system.

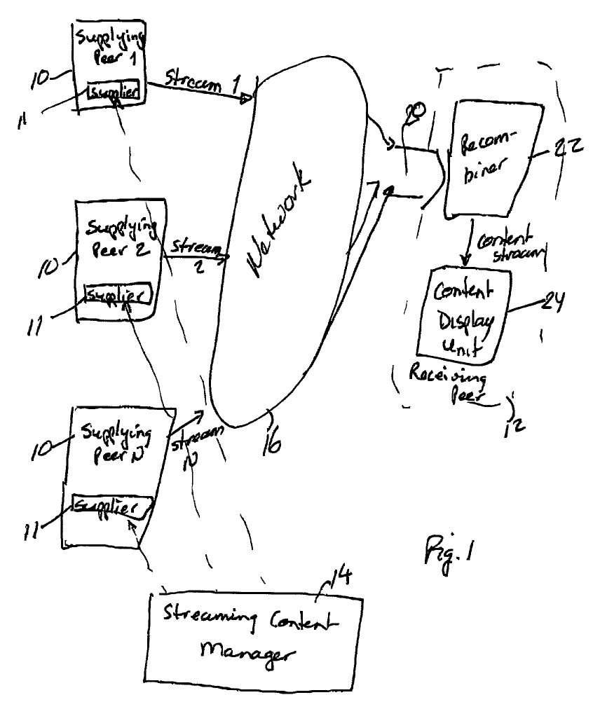

Reference is now made to FIG. 1, which illustrates a streaming content system,. constructed and operative in accordance with a preferred embodiment of the present invention. The system comprises a plurality N of supplying peers 10, shown in FIG. 1 supplying streams to a single receiving peer 12, and a streaming content manager 14. It will be appreciated that FIG. 1 is simplistic for purposes of clarity; the supplying peers 10 may supply more than one receiving peer 12.

Receiving peer 12 may have multiple connections open, one to each of supplying peers 10. Each supplying peer 10 has a supplier 11 that supplies a stream of data, via a network 16, such as the Internet, to receiving peer 12. While the bandwidth of each stream of data may be narrow, indicated by a thin line, the aggregate bandwidth of the multiple streams arriving at receiving peer 12 is wide, indicated by a wide arrow 20. For example, if the individual streams have a bandwidth of 64Kbits per second and there are 10 streams, then the bandwidth arriving at receiving peer 12 is 640Kbits per second.

As mentioned hereinabove, since the individual streams are of a narrow bandwidth. they may be supplied by peer-type computers connected to network 16, whose upload connection bandwidths are narrow, rather than by servers having wide bandwidth upload connections.

Receiving peer 12 typically comprises a recombiner 22, which recombines the separate streams into a single, stream of content, and (in the case of video streams) a content display unit 24, which displays the content stream generally as it arrives. An exemplary content display unit 24 is the Media Player, commercially available from Microsoft Corporation of the USA.

Recombiner 22 also communicates with streaming content manager 14 to initiate and control the communication between supplying and receiving peers.

Upon receiving a request from receiving peer 12 to download to it a particular content stream, such as a movie, streaming content manager 14 authorizes the suppliers 11 of a predefined number of supplying peers 10 to download their stream to the requesting receiving peer 12. Streaming content manager 14 also provides recombiner 22 of receiving peer 12 with the list of supplying peers 10 who have been authorized. In one embodiment, the list includes more than one supplying peer 10 for each stream to ensure a backup if one of the supplying peers 10 is either not available or supplies its stream too slowly.

It will be appreciated that a single supplying peer 10 can supply multiple streams, as long as each stream is provided along a separate connection to network 16. This is generally possible if the supplying peer 10 has a wide enough upload bandwidth.

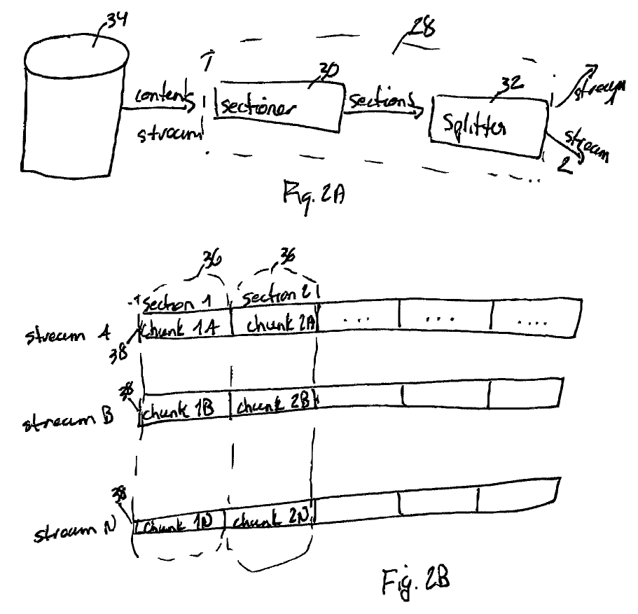

The present invention also divides the content stream, typically in an off-line process, into the separate streams needed for download and provides them to the various supplying peers 10. This is illustrated in more detail in FIGS. 2A and 2B., to which reference is now made. FIG. 2A illustrates the elements of a content divider 28 that performs the stream division and FIG. 2B illustrates how the content stream is divided.

Content divider 28 comprises a sectioner 30 and a splitter 32. Sectioner 30 divides a content stream, typically though not necessarily in compressed format, received from a content database 34, into a plurality of sections 36 (FIG. 2B), each a continuous piece of content.

Splitter 32 splits each section 36 into N “chunks” 38 (FIG. 2B) and prepares each chunk 38 for transmission. Each chunk 38 is of a transmittable size, such as 4 to 10Kbytes. Splitter 32 also provides the chunks 38 of a section 36 to separate streams, labeled A-N, where each stream comprises one chunk 38 from each section 36.

If desired, splitter 32 may also perform a demultiplexing operation, such as the first bit (or byte) of a group of N bits (or bytes) belongs to the first stream, the second bit of the group belongs to the second stream, etc. until the section 36 is finished. Alternatively or in addition, splitter 32 may perform an encryption operation, may add redundancy codes to the stream, or may perform any other desired operation on a section 36 before dividing it into chunks 38.

FIG. 2B shows two sections 1 and 2 divided among streams A-N. Section 1 is comprised of chunks 1A-1N where chunk 1A is part of stream A, chunk 1B is part of stream B, etc. Section 2 is similarly divided into chunks 2A-2N, where chunk 2A is part of stream A, etc. A section 36 generally may not be played until most of the chunks 38 belonging to it are received by recombiner 22. However, due to redundancy in the content stream and to any added redundancy codes, not all of the chunks 38 may be required.

Reference is now made to FIG. 3, which illustrates the elements of supplier 11 of FIG. 1. Supplier 11 comprises a stream storage unit 40. a network packager 42 and a supplier manager 44. Stream storage unit 40 stores the streams allocated to it, where, typically, each stream belongs to a different content stream, such as a different movie.

Supplier manager 44 controls the operation of supplier 11. It may receive a stream from content divider 28 for storing in stream storage 40 and it may receive instructions and/or authorizations regarding downloads to receiving peer 12. Upon receipt of a connection request from an authorized receiving peer 12, it may enable a connection to that receiving peer 12 thus allowing the desired stream to be seat to the receiving peer 12.

Supplier manager 44 also instructs network packager 42 to transmit the authorized stream to the authorized receiving peer 12. To do this, network packager 42 may transmit the currently requested chunks 38 for the authorized stream, received from stream storage unit 40, along the open connection to the authorized receiving peer 12. Network packager 42 then generally repeats this process for the remaining chunks of the stream, until supplier manager 44 indicates to network packager 42 to stop transmission

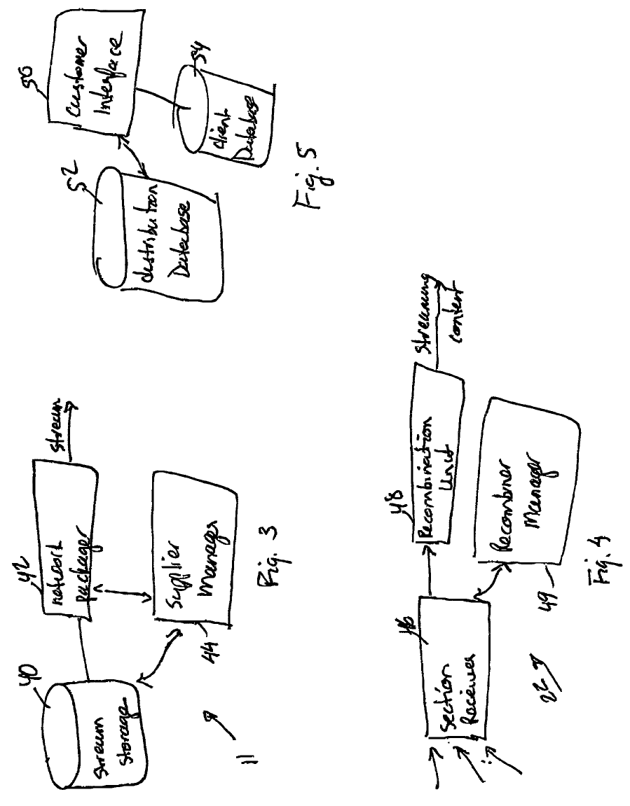

Reference is now made to FIG. 4, which illustrates the elements of recombiner 22. Recombiner 22 comprises a section receiver 46, a recombination unit 48 and a recombiner manager 49.

Section receiver 46 receives chunks 38 as they arrive from the multiple supplying peers 10. Section receiver 46 checks that all of the chunks 38 of a section 36 have been received, and, if so, passes the set of chunks 38 to recombination unit 48. The latter, after stripping the chunks 38 of any transmission packaging, performs the inverse of the operation performed by splitter 32. The section is now ready to be played by content display unit 24.

If section receiver 46 does not receive one of the chunks 38, it so notifies recombination unit 48. If there is sufficient redundancy information in the section as well as in any additional redundancy codes, recombination unit 48 may be able to reproduce the section despite the missing chunk.

However, section receiver 46 notifies recombiner manager 49 that a chunk did not arrive (which can occur if supplying peer 10 is shut down or otherwise disconnected from network 16) or that it arrived too slowly to be included in the chunks sent for inverse transformation. Recombiner manager 49 may then attempt to replace the supplying peer 10 of the no longer existent or slowly arriving stream with another supplying peer which has the same stream stored therein, in the expectation that a second supplying peer will be able to transfer the stream more quickly. To do so, recombiner manager 49 either uses the original list of supplying peers or it contacts streaming content manager 14 for the addressing of additional supplying peers 10 storing the troublesome stream.

Recombiner manager 49 communicates with streaming content manager 14 both to initiate the download and for any information needed to continue and finish the download. As the content streams are quite long (a movie takes 1½ to 4 hours to play) the period of communication between recombiner manager 49 and streaming content manager 14 is long, although communication typically is sporadic.

Reference is now made to FIG. 5, which illustrates further elements of streaming content manager 14. FIG. 5 shows a customer interface 50 a distribution database 52 and a client database 54.

Customer interface 50 checks the available videostreams, presents a list to the to customer, receives the customer's choice, and references the distribution database 52, for the list of peers for the selected videostream. Customer interface 50 then provides initial and updated lists of supplying peers 10 to recombiner 22. Customer interface 50 may also debit the user of receiving peer 12, if the content stream is one for which payment is required.

Customer interface 50 may check client database 54 to determine if the user of receiving peer 12 is an authorized user and may amend any debit information as necessary. Customer interface 50 also accesses distribution database 52 in order to provide the lists of supplying peers 10 for the requested content stream.

The methods and apparatus disclosed herein have been described without reference to specific hardware or software. Rather, the methods and apparatus have been described in a manner sufficient to enable persons of ordinary skill in the art to readily adapt commercially available hardware and software as may be needed to reduce any of the embodiments of the present invention to practice without undue experimentation and using conventional techniques.

It will be appreciated by persons skilled in the art that the present invention is not limited by what has been particularly shown and described herein above. Rather the scope of the invention is defined by the claims that follow:

1. A method for streaming content via a network to a receivers the method comprising:
receiving multiple streams, each generally from a different supplier, wherein said multiple streams together form said content.

2. A method according to claim 1 and wherein each said supplier has a narrower upload bandwidth than a download bandwidth of said receiver.

3. A method according to claim 1 and wherein said content is a videostream.

4. A method according to claim 1 and wherein said content is a movie.

5. A method according to claim 1 wherein each stream is formed of a plurality of separately transmittable chunks.

6. A method according to claim 5 wherein each cow is processed accord to one of the following processing methods: encryption, demultiplexing and scrambling.

7. A method according to claim 2 and wherein said content is a videostream.

8. A method according to claim 2 and wherein said content is a movie.

9. A method according to claim 5 and also comprising recombining a set of chunks, one from at least one of said multiple streams, into a section of said content.

10. A method according to claim 1 and also comprising displaying said content stream and replacing at least one said supplier during said displaying.

12. A method for streaming content via a network to a receiver, the method comprising:
providing a plurality of streams to a plurality of different suppliers; and
receiving multiple streams, each generally from a different supplier, wherein said multiple streams together form said content.
